(19) United States
(12) Patent Application Publication
(10) Pub. No.: US 2010/0221606 A1
(43) Pub. Date: Sep. 2, 2010

(54) ENERGY STORAGE DEVICE WITH POROUS ELECTRODE

(76) Inventors: Omkaram Nalamasu, San Jose, CA (US); Steven Verhaverbeke, San Francisco, CA (US)

Correspondence Address: APPLIED MATERIALS;C/O PILLSBURY WINTHROP SHAW PITTMAN LLP, P .O . BOX 10500, MCLEAN, VA, 22120, US

(21) Appl. No.: 12/396,277

(22) Filed: Mar. 2, 2009

(51) Int. Cl. H01M 4/00; C25D 11/02

(52) U.S. Cl. 429/209; 205/157; 205/137

(57) ABSTRACT

A method of fabricating an energy storage device with a large surface area electrode comprises: providing an electrically conductive substrate; depositing a semiconductor layer on the electrically conductive substrate, the semiconductor layer being a first electrode; anodizing the semiconductor layer, wherein the anodization forms pores in the semiconductor layer, increasing the surface area of the first electrode; after the anodization, providing an electrolyte and a second electrode to form the energy storage device. The substrate may be a continuous film and the electrode of the energy storage device may be fabricated using linear processing tools. The semiconductor may be silicon and the deposition tool may be a thermal spray tool. Furthermore, the semiconductor layer may be amorphous. The energy storage device may be rolled into a cylindrical shape. The energy storage device may be a battery, a capacitor or an ultracapacitor.

### FIELD OF THE INVENTION

The present invention relates generally to energy storage devices, and more specifically to energy storage devices with porous electrodes.

### BACKGROUND OF THE INVENTION

All solid state Thin Film Batteries (TFB) are known to exhibit several advantages over conventional battery technology such as superior form factors, cycle life, power capability and safety. However, there is a need for cost effective and high-volume manufacturing (HVM) compatible fabrication technologies to enable broad market applicability of TFBs. Further, there is a need to improve the performance of TFBs. One approach for improving TFB performance is to increase battery electrode surface area without impacting the battery size. There is a need for methods for increasing TFB performance which are compatible with HVM and are low cost.

An approach for increasing electrode surface area by anodizing a silicon wafer to produce a porous electrode is described by Shin et al., “Porous silicon negative electrodes for rechargeable lithium batteries,” Journal of Power Sources, vol. 138, no. 1-2, pp 314-320, 2005. However, the process and structure described by Shin et al. is based on processing of silicon wafers to make large area electrodes—this is too expensive, undesirable for HVM and is not sufficiently mechanically flexible to produce desired battery form factors. There is a need for lower cost, HVM compatible processes and structures. Furthermore, there is a need for flexible TFB cells which can readily be manipulated into desired form factors, such as rolled electrodes for cylindrical batteries.

### SUMMARY OF THE INVENTION

In general, embodiments of this invention contemplate providing a high-volume manufacturing solution for the fabrication of energy storage devices with large area porous electrodes. Embodiments of the present invention contemplate an alternative method of manufacturing energy storage devices using low cost, high-throughput processes. This approach includes the use of processes compatible with linear processing tools and continuous thin film substrates. Embodiments of the present invention contemplate porous electrodes made from a range of semiconductor materials, such as silicon, germanium, silicon-germanium, and other semiconductors and compound semiconductors. The semiconductor materials may be crystalline, polycrystalline or amorphous. More specifically, embodiments of the present invention may include processes combining: (1) deposition of a thin film semiconductor material; and (2) anodization of the thin film semiconductor, to produce a large surface area electrode. Furthermore, embodiments of this invention may provide flexible electrodes that permit a wide range of energy storage device form factors. For example, the energy storage device may be rolled to form a cylindrical battery or capacitor. Energy storage devices according to embodiments of the present invention may include batteries, thin film batteries (TFBs), capacitors and ultracapacitors.

According to aspects of this invention, a method of fabricating an energy storage device with a large surface area electrode comprises: providing an electrically conductive substrate; depositing a semiconductor layer on said electrically conductive substrate, said semiconductor layer being a first electrode; anodizing said semiconductor layer, wherein said anodization forms pores in said semiconductor layer, increasing the surface area of said first electrode; after said anodization, providing an electrolyte and a second electrode to form said energy storage device.

According to yet further aspects of this invention, an electrode of an energy storage device comprises: a thin film metal current collector; and a large surface area thin film semiconductor electrode having upper and lower surfaces, the lower surface being attached to the current collector, the thin film having pores extending from the upper surface into the thin film; wherein the semiconductor material between the pores is electrically conductive and electrically connected through the semiconductor electrode to the current collector.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic representation of anodization of a silicon film, according to embodiments of the invention;

FIG. 2 is a representation of a linear processing system for anodization of a continuous silicon film, according to embodiments of the invention;

FIG. 3 shows a cross-section of an energy storage device, according to embodiments of the invention;

FIG. 4 shows an energy storage device configured as a roll, according to embodiments of the invention; and

FIG. 5 shows energy storage devices configured in a stack, according to embodiments of the invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In general, embodiments of this invention provide a high-volume manufacturing solution, at low cost and with high throughput for the fabrication of energy storage devices with large area porous electrodes. The following description provides examples of large area electrodes made of porous silicon. However, the present invention also contemplates porous electrodes made from a range of semiconductor materials, such as germanium, silicon-germanium, and other semiconducting elements and compounds. The semiconductor materials may be crystalline, polycrystalline or amorphous. The approach of the present invention includes, but is not limited to, the use of processes compatible with linear processing tools and continuous thin film substrates. Embodiments of the present invention may include processes combining: (1) deposition of a thin film semiconductor material; and (2) anodization of the thin film semiconductor, to produce a large surface area electrode.

Energy storage devices are described generally herein, and specific examples of TFB devices are provided. However, embodiments of the present invention are not limited to TFBs, but are applicable to energy storage devices generally, including batteries, TFBs, capacitors and ultracapacitors.

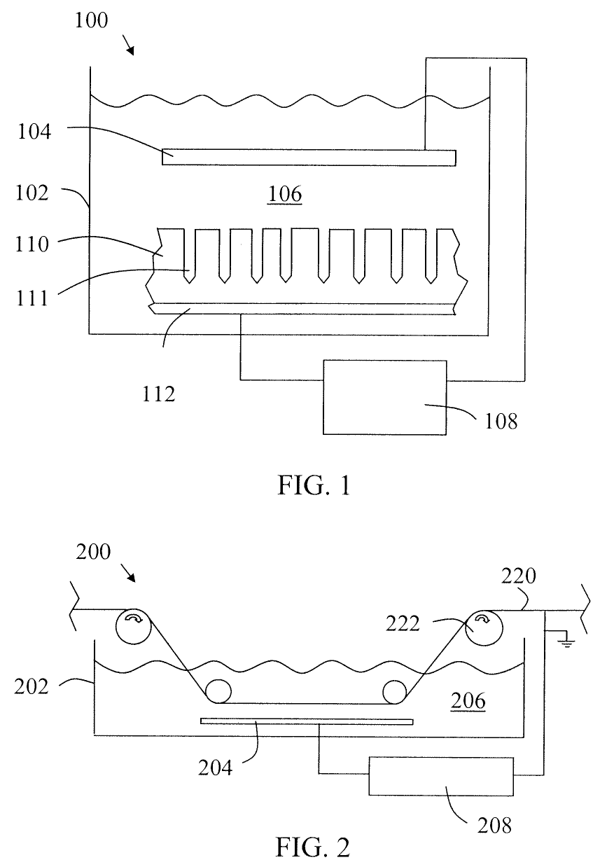

FIG. 1 shows an electrochemical processing system 100 configured for anodization of a semiconductor film 110. The system 100 includes a processing tank 102 which contains an electrolyte 106, a cathode 104 and an anode comprised of the semiconductor film 110 on a metal substrate 112. The metal substrate 112 and the cathode 104 are connected to a power supply and controller 108. The controller 108 is operated in a constant current mode in the particular configuration shown in FIG. 1, although anodization may also be achieved in a constant voltage mode, as is familiar to those skilled in the art. The anodization process results in pores 111 being formed in the semiconductor film 110. The metal substrate 112 may need to be protected from the electrolyte, in which case a protective coating may be applied to the substrate or a special holder may be utilized.

Although not shown, the electrochemical processing system 100 of FIG. 1 may also include a means for circulating the electrolyte 106 within the tank 102, for example using a stirrer or a circulation pump. Furthermore, the system 100 may include a light source. The specific configuration of the processing system 100 is shown for purposes of illustration; there are many other configurations and methods for anodization of semiconductors that are known to those skilled in the art that may be utilized with the present invention.

The electrolyte 106 may comprise a mixture of hydrofluoric acid (HF), water and glacial acetic acid (CH₃COOH). A mixture of HF (49%-w) and glacial acetic acid in a volumetric ratio of 1:1 was found to provide uniform etching of lightly-doped p-type (100) crystalline silicon at a constant current of 100 mA cm⁻² in the dark. This mixture was found to provide a more macroscopically uniform porous layer than when using ethanol in place of the glacial acetic acid, with an electrolyte comprising, by volume, 70% of HF (49%-w) and 30% ethanol.

Higher volumetric fractions of glacial acetic acid in the above electrolyte provide for more uniform etching of silicon. This is due to high volume fractions of glacial acetic acid resulting in more electrically resistive electrolytes. However, the HF concentration needs to be sufficient to support a high enough rate of pore formation. On the other hand, HF is usually sourced from a 49%-w solution. Therefore, when the HF concentration gets too high, the water concentration gets too high, since 51%-w of the commonly used HF source solution is water. Hence it is preferable to use 30-70%-volume glacial acetic acid, with the balance being HF 49%-w solution. More preferably, a 40-60%-volume solution is used of glacial acetic acid, with the balance being HF 49%-w solution.

The objective of the anodization process is to increase the surface area of the semiconductor film 110 which can act as a battery cell electrode. Consequently, the anodization process must be controlled to form a porous structure and avoid electropolishing of the semiconductor film. Further, it is preferred that the semiconductor material remaining between the pores 111 remains electrically conductive, such that there is a current path from the surface of the porous electrode, through the porous layer and to the metal substrate 112 (current collector). Furthermore, the pore size and spacing is dependent on the anodization conditions and the doping level of the semiconductor material. The dopant type and level and the anodization conditions are chosen to meet a desired porosity and maintain electrical conductivity of the porous semiconductor. The anodization may be controlled so that pores 111 extend part way through or completely through the semiconductor film 110.

FIG. 2 shows a schematic of a high throughput linear electrochemical processing system 200. System 200 includes a tank 202 which contains an electrolyte 206, a cathode 204, and a continuous thin film 220. System 200 is configured for electrochemical processing of the continuous thin film 220 which is directed through the processing tank 202 by a plurality of rollers 222. A controller 208 is connected between the cathode 204 and the continuous thin film 220, which is held at earth potential. The controller 208 is operated as described above for controller 108. The continuous thin film 220 may be comprised of a semiconductor film on a thin flexible metal substrate.

Further to the configuration shown in FIG. 2, anodization may be carried out using a spray tool, rather than requiring complete immersion in an electrolyte.

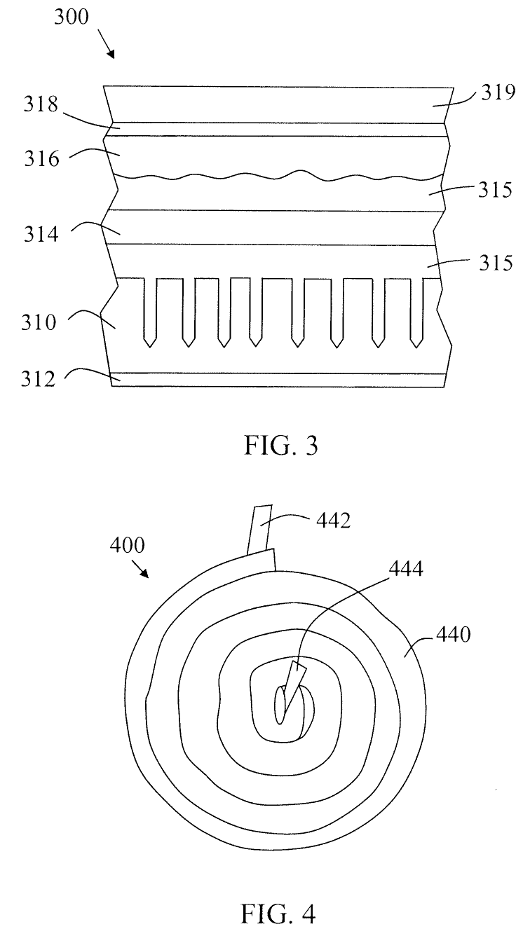

FIG. 3 shows a cross section of an energy storage device, which in this example is a battery cell 300. The battery cell 300 comprises an anode current collector 312, a porous anode 310, a separator 314, a battery electrolyte 315, a cathode 316 and a cathode current collector 318. The anode current collector 312 may be a metal such as copper, chosen for its good electrical conductivity, mechanical stability and flexibility. The porous anode 310 may be a porous semiconductor material such as porous silicon, porous germanium, etc. The semiconductor material is chosen for its suitability for forming a porous structure using electrochemical anodization, where the semiconductor thin film is rendered porous by anodization, without compromising the electrical conductivity of the remaining semiconductor material—in other words, the semiconductor material between the pores is electrically conductive and electrically connected through the semiconductor anode 310 to the anode current collector 312. The battery electrolyte 315 may be a chemical such as propylene carbonate, ethylene carbonate, LiPF₆, etc. The separator 314 may be porous polyethylene, porous polypropylene, etc. The cathode 316 may be a metal foil, such as lithium foil, or a material such as LiCoO₂. The cathode current collector may be aluminum. Note that the electrolytes, separators and electrodes must be matched to provide desirable battery performance.

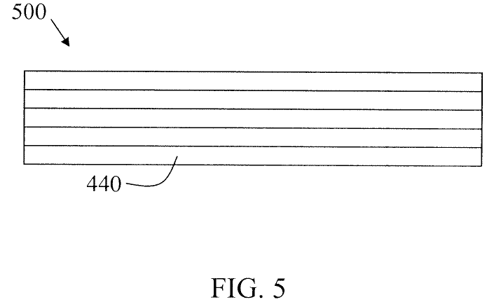

FIG. 4 shows a cylindrical energy storage device, which in this example is a cylindrical battery 400. Flexible thin battery cell 440 includes an isolation layer—such as an insulating layer covering one surface of the cell 440—which prevents shorting of the battery electrodes when the battery cell is rolled up. Electrical contacts 442 and 444 are made to the top and bottom surfaces, respectively, of the battery cell 440. FIG. 5 shows an alternative configuration of the battery cells 440, forming a battery stack 500. The battery cells 440 within the battery stack 500 may be electrically connected together either in series or in parallel. (The electrical connections are not shown.)

Referring again to FIG. 3, a method for fabricating an embodiment of the battery cell 300 is described. A metal film is provided for the anode current collector (ACC) 312. A thin film 310 of semiconductor material is deposited on the ACC 312. Suitable deposition processes may include processes such as chemical vapor deposition (CVD), physical vapor deposition (PVD), plasma enhanced chemical vapor deposition (PECVD), and thermal spray in an inert environment. The ACC 312 may be a continuous thin metal film and may be moved linearly through the semiconductor deposition tool. A reel-to-reel system may be utilized for linear movement of the ACC 312. The semiconductor thin film 310 is anodized to increase the electrode surface area. In the case of a continuous thin film, the film may be moved through the anodization tool during the anodization process. Again, a reel-to-reel system may be used. A separator film 314 is applied to the surface of the anodized semiconductor electrode 310. A cathode 316 and cathode current collector (CCC) 318 are applied to the top surface of the separator 314. The cathode 316 and CCC 318 are most conveniently prepared by depositing the cathode material on the CCC 318. The stack may then be covered by an insulating layer 319 and then rolled to form a cylindrical battery 400, as shown in FIG. 4, or stacked to form a rectangular format battery, as shown in FIG. 5. The battery cells 300, 440 are then injected with battery electrolyte 315 and are sealed.

The methods of the present invention may also be applicable to forming electrodes for energy storage devices using porous germanium. Germanium thin films may be deposited using HVM compatible processes, as described above for silicon film deposition, and the germanium may be rendered porous following the general anodization methods described above for silicon. Furthermore, the methods of the present invention may also be applicable to forming electrodes for energy storage devices using porous compound semiconductors such as SiGe, GaAs, etc.

Although the present invention has been particularly described with reference to embodiments thereof, it should be readily apparent to those of ordinary skill in the art that changes and modifications in the form and details may be made without departing from the spirit and scope of the invention. It is intended that the appended claims encompass such changes and modifications. The following claims define the present invention.

What is claimed is:

1. A method of fabricating an energy storage device with a large surface area electrode, comprising:
providing an electrically conductive substrate;
depositing a semiconductor layer on said electrically conductive substrate, said semiconductor layer being a first electrode;
anodizing said semiconductor layer, wherein said anodization forms pores in said semiconductor layer, increasing the surface area of said first electrode;
after said anodization, providing an electrolyte and a second electrode to form said energy storage device.

2. A method as in claim 1, wherein said electrically conductive substrate is a continuous thin film.

3. A method as in claim 2, wherein during said depositing, said electrically conductive substrate is moved linearly through a semiconductor deposition tool.

4. A method as in claim 2, wherein during said anodizing, said electrically conductive substrate is moved linearly through an anodization tool.

5. A method as in claim 2, wherein said electrically conductive substrate is movable between two reels.

6. A method as in claim 1, wherein said semiconductor deposition tool is a thermal spray deposition tool.

7. A method as in claim 1, wherein said semiconductor deposition tool is selected from the group consisting of a physical vapor deposition tool, a chemical vapor deposition tool and a plasma enhanced chemical vapor deposition tool.

8. A method as in claim 1, wherein said anodization is implemented using an electrolyte consisting of hydrofluoric acid and acetic acid.

9. A method as in claim 1, wherein said semiconductor layer is chosen from the group consisting of silicon, germanium, silicon-germanium and gallium arsenide.

10. A method as in claim 1 wherein said semiconductor is amorphous.

11. A method as in claim 1, wherein said semiconductor is silicon.

12. A method as in claim 11, wherein said anodization is implemented using an electrolyte comprising a mixture of 49% hydrofluoric acid and glacial acetic acid, and wherein said electrolyte comprises greater than 30% by volume glacial acetic acid.

13. A method as in claim 11, wherein said anodization is implemented using an electrolyte comprising a mixture of 49% hydrofluoric acid and glacial acetic acid, and wherein said electrolyte comprises glacial acetic acid by volume in the range of 30% to 70%.

14. A method as in claim 11, wherein said anodization is implemented using an electrolyte comprising a mixture of 49% hydrofluoric acid and glacial acetic acid, and wherein said electrolyte comprises glacial acetic acid by volume in the range of 40% to 60%.

15. A method as in claim 1, further comprising:
providing an insulating layer on said energy storage device; and
rolling said energy storage device into a cylindrical shape, wherein said insulating layer electrically isolates said substrate and said electrode in the roll.

16. An electrode of an energy storage device comprising:
a thin film metal anode current collector; and
a large surface area thin film semiconductor anode having upper and lower surfaces, said lower surface being attached to said anode current collector, said thin film having pores extending from said upper surface into said thin film;
wherein the semiconductor material between said pores is electrically conductive and electrically connected through said semiconductor anode to said anode current collector.

17. An electrode as in claim 16, wherein said semiconductor is silicon.

18. An electrode as in claim 16, wherein said semiconductor is an amorphous semiconductor.

19. An electrode as in claim 16, wherein said electrode is flexible.

20. An electrode as in claim 19, wherein said energy storage device is configured in the shape of a cylindrical roll.

21. An electrode as in claim 16, wherein said energy storage device is a thin film battery.
